(19) United States
(12) Patent Application Publication
(10) Pub. No.: US 2024/0430818 A1
(43) Pub. Date: Dec. 26, 2024

(54) DEVICE POSITION DETERMINATION RELATIVE TO A HUMAN BODY

(71) Applicant: QUALCOMM Incorporated, San Diego, CA (US)

(72) Inventors: John FORRESTER, San Diego, CA (US); Paul GUCKIAN, La Jolla, CA (US); Justin MCGLOIN, Los Altos, CA (US); David Loweth WINSLOW, San Diego, CA (US); Erwin SPITS, Utrecht (NL)

(21) Appl. No.: 18/747,776

(22) Filed: Jun. 19, 2024

Related U.S. Application Data
(60) Provisional application No. 63/510,075, filed on Jun. 23, 2023.

(51) Int. Cl. H04W 52/28; H04B 1/3827; H04W 52/14

(52) U.S. Cl. CPC H04W 52/282; H04B 1/3838; H04W 52/146

(57) ABSTRACT

Certain aspects of the present disclosure provide techniques and apparatus for complying with radio frequency (RF) exposure limits via device positioning relative to a human body. An example method of wireless communication includes obtaining first information associated with one or more sensors. The method further includes obtaining second information associated with a mode of using the wireless device. The method further includes determining a position of the wireless device relative to a human body based at least in part on the first information and the second information. The method further includes transmitting a signal at a transmit power in compliance with an RF exposure limit based at least in part on the determined position of the wireless device.

### CROSS-REFERENCE TO RELATED APPLICATION

This application claims the benefit of U.S. Provisional Patent Application Ser. No. 63/510,075, filed Jun. 23, 2023, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### Description of Related Art

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly to comply with the RF exposure limit.

### SUMMARY

Certain aspects of the subject matter described in this disclosure can be implemented in a method of wireless communication by a wireless device. The method includes obtaining first information associated with one or more sensors. The method further includes obtaining second information associated with a mode of using the wireless device. The method further includes determining a position of the wireless device relative to a human body based at least in part on the first information and the second information. The method further includes transmitting a signal at a transmit power in compliance with a radio frequency (RF) exposure limit based at least in part on the determined position of the wireless device.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to obtain first information associated with one or more sensors, obtain second information associated with a mode of using the apparatus, determine a position of the apparatus relative to a human body based at least in part on the first information and the second information, and control transmission of a signal at a transmit power in compliance with a radio frequency (RF) exposure limit based at least in part on the determined position of the apparatus.

Certain aspects of the subject matter described in this disclosure can be implemented in an apparatus for wireless communication. The apparatus generally includes means for obtaining first information associated with one or more sensors. The apparatus also includes means for obtaining second information associated with a mode of using the apparatus. The apparatus also includes means for determining a position of the apparatus relative to a human body based at least in part on the first information and the second information. The apparatus further includes means for transmitting a signal at a transmit power in compliance with a radio frequency (RF) exposure limit based at least in part on the determined position of the apparatus.

Certain aspects of the subject matter described in this disclosure can be implemented in a computer-readable medium. The computer-readable medium has instructions stored thereon, that when executed by an apparatus, cause the apparatus to perform an operation. The operation generally includes obtaining first information associated with one or more sensors. The operation also includes obtaining second information associated with a mode of using the apparatus. The operation also includes determining a position of the apparatus relative to a human body based at least in part on the first information and the second information. The operation further includes transmitting a signal at a transmit power in compliance with a radio frequency (RF) exposure limit based at least in part on the determined position of the apparatus.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in

compliance with an RF exposure limit, in accordance with certain aspects of the present disclosure.

FIG. 4 illustrates a diagram of example wireless device positions relative to a profile of an example human body, in accordance with certain aspects of the present disclosure.

FIG. 5 is an example workflow for determining a device position and applying the determined position in an RF exposure evaluation, in accordance with certain aspects of the present disclosure.

FIG. 6 is a diagram of example device movements over time associated with determining the device position, in accordance with certain aspects of the present disclosure.

FIG. 7 is a flow diagram illustrating example operations for wireless communication by a wireless device, in accordance with certain aspects of the present disclosure.

FIG. 8 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for accurately determining device positioning relative to a human body, for example for complying with radio frequency (RF) exposure limits according to different RF exposure scenarios, including device positioning, as an illustrative example.

In certain cases, RF exposure compliance for a wireless device may depend on an RF exposure scenario exhibited by the wireless device. For example, the wireless device may be near the user's head, body, and/or hand, where the RF exposure to human tissue may be higher. In some cases, the wireless device may be positioned away from the user's body (e.g., when charging or being used as a hotspot), where the RF exposure to human tissue may be lower. RF exposure compliance may be assessed differently depending on the RF exposure scenario exhibited by the wireless device.

A wireless device may use sensing circuitry to determine certain RF exposure scenario(s) of the wireless device. For example, the sensing circuitry may be used to determine whether the wireless device is positioned on or off the user's body, and/or whether the wireless device is in proximity to human tissue when positioned off the user's body. As a result, when in an on-body scenario, the wireless device may assume the wireless device is positioned in the most conservative RF exposure scenario (which may be assessed to have the lowest RF exposure limit (e.g., a time-averaged transmit power limit)), such as near the user's head. Such an assumption may affect the wireless communication performance. In some cases, the sensing information available from the sensing circuitry may not facilitate a determination of how the wireless device is held (e.g., in the left hand, right hand, body-worn, etc.) or where the wireless device is positioned on the body (e.g., left torso, right torso, left hip, right hip, etc.). In certain cases, the sensing information available from the sensing circuitry may have a limited confidence in determining the wireless device's position relative to a human body.

Aspects of the present disclosure provide apparatus and methods for accurately determining a position of a wireless device relative to a human body using multiple sources of information, such as sensor information and/or usage information associated with the wireless device. The usage information may include, for example, whether a display is on or off, what application is currently running on the wireless device, and/or what audio input or output device is being used. In some cases, the usage information may supplement sensing information obtained from sensing circuitry to determine the device position. As an example, the usage information may indicate that the user is holding the wireless device in the user's hands, for example, due to the active application being a game and there being indications of user touches on the display. The wireless device may select the RF exposure assessment associated with hand exposure when determining a transmit power in compliance with the RF exposure limit. In some cases, the wireless device may confirm the device position indicated by the usage information via the sensing information, for example, via a human tissue proximity reading (e.g., via a proximity sensor or a radar detection using a frequency-modulated continuous-wave (FMCW) sensor), or vice versa. The multiple types of information may enable an increased confidence in determining the position of the device relative to the user's body.

The apparatus and methods for the device position determination described herein may provide various advantages. The device position determination may facilitate increased confidence in determining the device position (e.g., where and how the transmitting device is being used near the body), which may allow the wireless device to use the determined device position for RF exposure compliance. For example, the wireless device may select the RF exposure assessment corresponding to the current RF exposure scenario based on the determined device position. In some cases, the device position determination may improve wireless communication performance, including, for example, an increased throughput, decreased latency, and/or increased transmission range. The improved performance may be attributable to assessing the RF exposure limit in association with the actual RF exposure scenario instead of a conservative assumption of the RF exposure scenario.

The following description provides examples of device position determination for RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transceivers, and/or RATs (e.g., wireless wide area network (WWAN), wireless local area network (WLAN), short-range communications (e.g., Bluetooth), non-terrestrial communications, device-to-device (D2D) communications, vehicle-to-everything (V2X) communications, etc.) used for wireless communications. For example, for uplink carrier aggregation (or multi-connectivity) in WWAN communications, each of the active component carriers used for wireless communications may be treated as a separate radio. Similarly, multi-band transmissions for Institute of Electrical and Electronics Engineers (IEEE) 802.11 may be treated as separate radios for each frequency band (e.g., 2.4 gigahertz (GHz), 5 GHz, or 6 GHz).

The techniques described herein may be used for various wireless networks and radio technologies. While aspects may be described herein using terminology commonly associated with Third Generation (3G), Fourth Generation (4G), and/or Fifth Generation (5G) (e.g., 5G New Radio (NR)) wireless technologies, aspects of the present disclosure can be applied in other generation-based communication systems and/or to wireless technologies such as IEEE 802.11, 802.15, etc.

### Example Wireless Communication Network and Devices

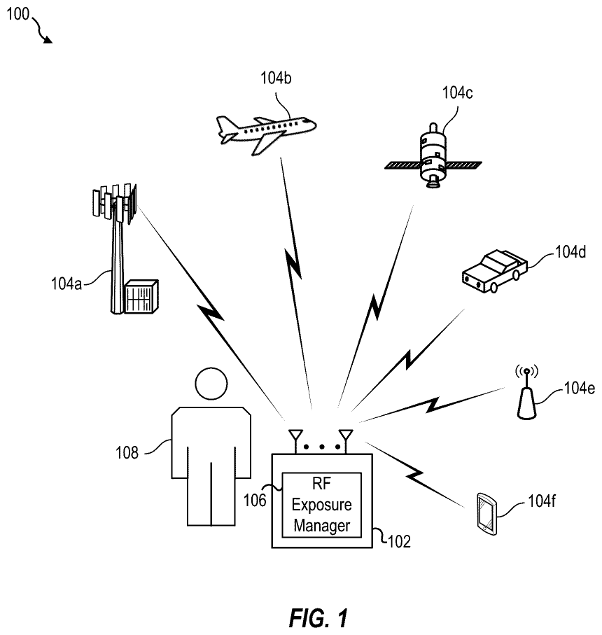

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio system (e.g., a 5G NR network), an Evolved Universal Terrestrial Radio Access (E-UTRA) system (e.g., a 4G network), a Universal Mobile Telecommunications System (UMTS) (e.g., a Second Generation (2G)/3G network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a D2D communications network or a short-range communications system, such as Bluetooth communications.

As illustrated in FIG. 1, the wireless communication system 100 may include a first wireless device 102 communicating with any of various second wireless devices 104a-104f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may be positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit and/or how that limit is assessed may depend on the corresponding exposure scenario (e.g., head exposure, extremity (e.g., hand) exposure, body (body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes an RF exposure manager 106 that determines a transmit power in compliance with an RF exposure limit based at least in part on a position of the first wireless device 102 relative to a human as determined from multiple pieces of information, such as sensor information and/or device usage information, in accordance with aspects of the present disclosure.

The second wireless devices 104a-104f may include, for example, a base station 104a, an aircraft 104b, a satellite 104c, a vehicle 104d, an access point (AP) 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a STA, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz or greater are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

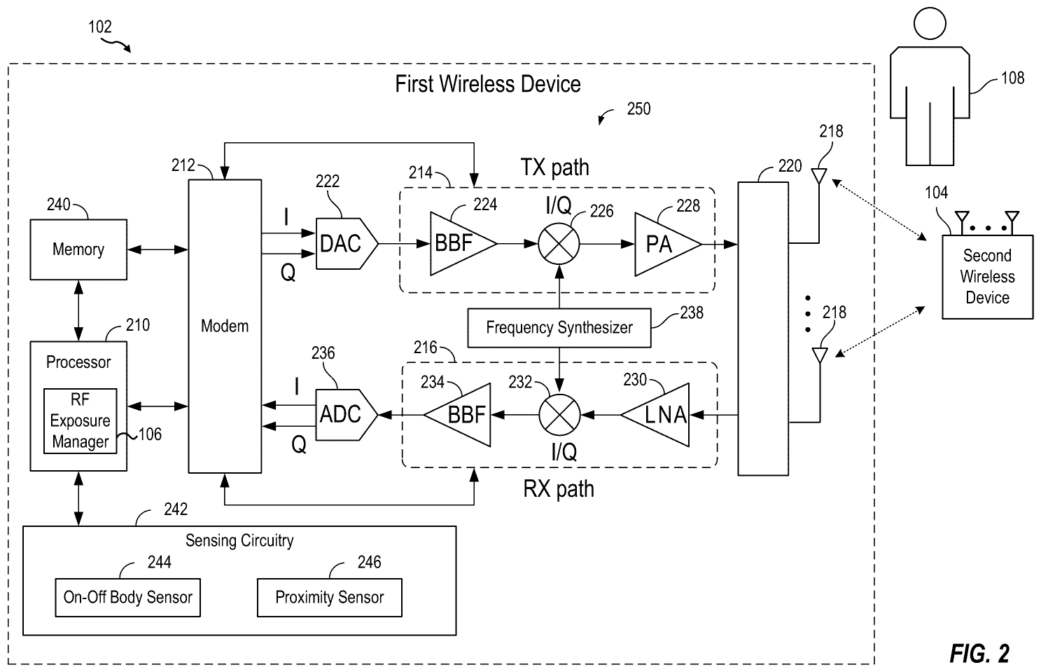

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a radio access technology (RAT). For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the first wireless device 102 may communicate via multiple-input, multiple-output (MIMO) signals. The first wireless device 102 may transmit more than one signal via multiple antennas 218a, 218b (collectively “the antennas 218”) to the second wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the first wireless device 102 and the second wireless device 104.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. For example, the processor 210 may be representative of a co-processor (e.g., a microprocessor) associated with the modem 212, and the modem 212 may be representative of an ASIC including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

In certain aspects, the first wireless device 102 may include sensing circuitry 242 that may be used in an effort to determine the position of the wireless device relative to the human 108, and thus, a corresponding RF exposure scenario, as further described herein. As further described herein, the position of the wireless device may be determined using the sensor information and/or device usage information, for example, to improve the confidence in or accuracy of the position determination and/or to enhance the granularity of the position determination. The processor 210 may be in communication with the sensing circuitry 242 to read measurements from the sensing circuitry 242. The measurements of the sensing circuitry 242 may facilitate a determination of an RF exposure scenario, which may correspond to an RF exposure limit and/or assessment as further described herein. For example, the sensing circuitry 242 may detect certain movements of the wireless device, such as accelerations. The detected movements may indicate that the first wireless device 102 is on the body of a user (e.g., in the pocket or hand), whereas, the lack of movements or diminished movements may indicate that the first wireless device 102 is off the body of the user (e.g., set on a desk or charging station).

The sensing circuitry 242 may include an on-off body sensor 244, a proximity sensor 246, and/or any other suitable sensor that may be used for detecting the position of the device relative to the human 108. The on-off body sensor 244 may detect whether the first wireless device 102 is positioned on or off human tissue. For example, the on-off body sensor 244 may detect that the first wireless device 102 is in a pocket of a user or held in a hand of the user. The on-off body sensor 244 may include one or more accelerometers, an inertial measurement unit (IMU), a capacitive sensor, an infrared sensor, a photonic sensor, a pressure sensor, a temperature sensor, etc.

The proximity sensor 246 may detect whether human tissue is nearby or proximate to the first wireless device 102. In some cases, the proximity sensor 246 may determine the distance between the first wireless device 102 and human tissue. For example, the proximity sensor 246 may detect that there is no human tissue within a certain range of the first wireless device 102 to enable a higher transmit power, such as in a hotspot exposure scenario. In certain aspects, the proximity sensor 246 may enable the detection of particular appendages of the body, such as certain finger(s) being used to hold the first wireless device 102. The proximity sensor 246 may include a radar sensor, a FMCW sensor, a transceiver (e.g., the radio 250), an RF sensor (e.g., any sensor that uses RF for detection), an RF impedance sensor, etc. The RF impedance sensor may include a feedback receive path (e.g., the RX path 216 or another RX path that typically does not process communications from another device) that monitors the RF environment for human tissue proximate to the first wireless device 102, for example, via a voltage standing wave ratio (VSWR) between a transmit path (e.g., the TX path 214) and a receive path (e.g., the RX path 216).

In certain cases, the proximity sensor 246 (e.g., an FMCW radar) may transmit a wide bandwidth RF pulse and monitor for reflections to detect objects proximate to the first wireless device 102 using radar. In certain cases, where a transceiver may be used as the proximity sensor, the transceiver may use a feedback receive path to perform the proximity sensing. For example, the transceiver may output a signal via the TX path 214 and monitor for any reflections indicative of an object or human tissue via the RX path 216. Thus, the proximity sensor 246 may include the radio 250 and/or one or more other radios of the first wireless device 102. In certain aspects, the proximity sensor 246 may detect certain antenna-user interactions(s), for example, whether the user is blocking a particular antenna (antenna array or antenna module) with the user's hand or finger. For example, the first wireless device 102 may monitor a VSWR (and/or any other suitable measure of the RF environment) via a feedback receive path (e.g., the RX path 216) to identify whether human tissue (e.g., finger(s) or hand) is proximate to a particular antenna (antenna array or antenna module) among multiple antennas of the first wireless device 102. Sensing circuitry 242 may include sensors other than those discussed above and/or illustrated in FIG. 2.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands), under a proposed regulation.

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

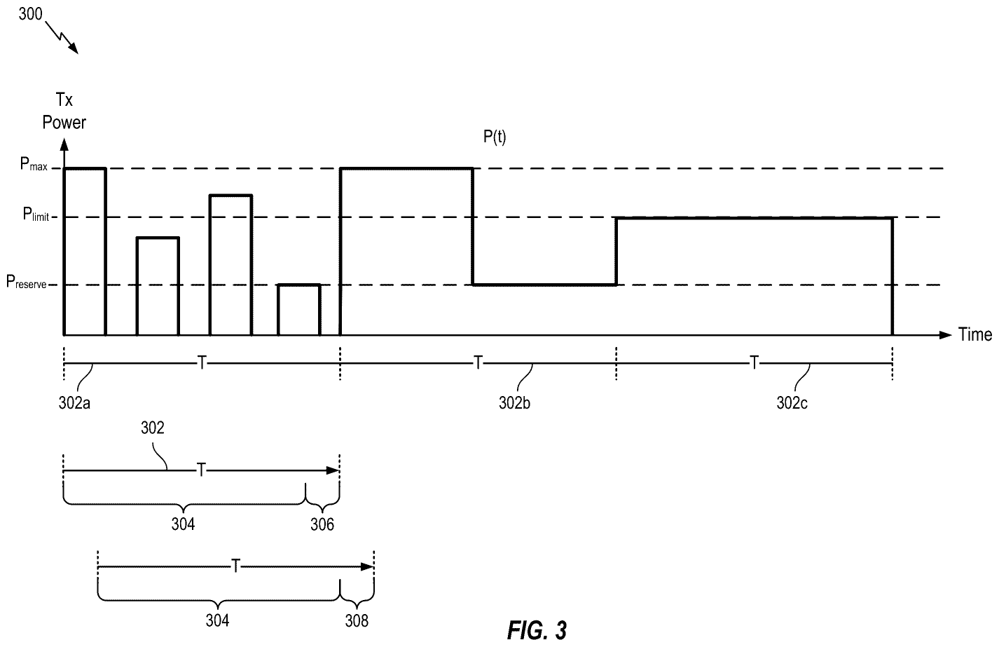

FIG. 3 is a graph 300 of a transmit power over time (P(t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling, high priority communications, low latency communications, highly reliable communications, etc.). Pᵣₑₛₑᵣᵥₑ may be used to reserve transmit power for at least a portion of the time window 302 for certain transmissions (e.g., control signaling).

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the total area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. The duty cycle may be an effective duty cycle associated with the total transmit time of one or more transmissions in the time period. For example, in the first time window 302a, the duty cycle may be greater than 50% of the duration of the time window (T), whereas in the second time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

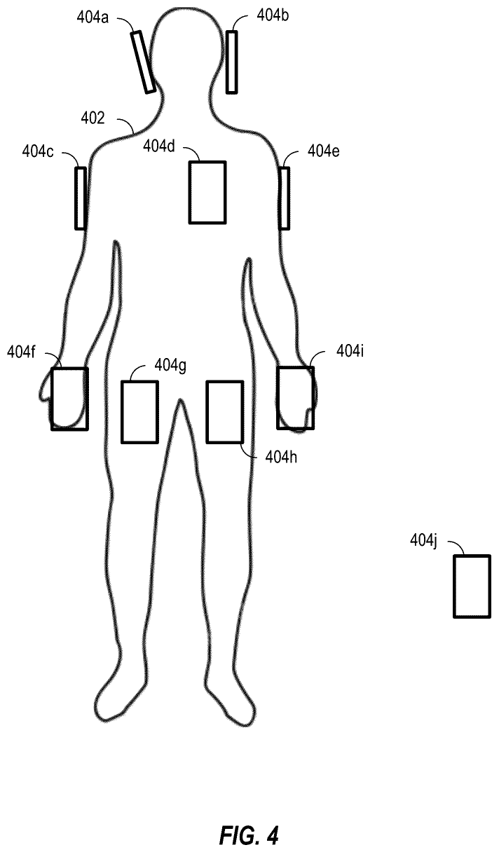

Depending on use case (e.g., user behavior), over time, a wireless communication device may expose different human tissue or different parts of the human body to RF energy at different times. FIG. 4 illustrates a diagram of example wireless device positions 404a-404j relative to a profile of an example human body 402. For example, in a first occasion, the wireless device may be held next to the head of a user for a voice call (e.g., at position 404a, 404b), where the RF exposure is to the head (and potentially to a hand holding the phone); and in a second period of time, the user may switch to using Bluetooth for the voice call and place the wireless device in a pocket (e.g., at position 404d, 404g, 404h), where the RF exposure in the second occasion is to both head (from a Bluetooth radio) and torso (from the wireless device). At other times, the user may position the wireless device in other positions, such as any of positions 404c-404j.

In certain aspects, the positions 404a-404j may correspond to certain exposure scenarios (or exposure categories), where a particular exposure scenario (or exposure category) may apply separate transmit power limit(s) from another exposure scenario (or exposure category) and/or may be assessed differently. For example, an exposure or exposure limit may be assessed or selected based on an assumed or regulated distance from the human 108 corresponding to one or more exposure scenarios or categories. The exposure scenarios may include a head exposure scenario, where the head of a user is exposed to RF energy by the wireless device, for example, corresponding to positions 404a, 404b. The exposure scenarios may include a body-worn (or body) exposure scenario, where the body or torso of the user is exposed to RF energy by the wireless device, for example, corresponding to positions 404d, 404g, 404h. The exposure scenarios may include an extremity exposure scenario, where the hands, wrists, feet, ankles, and/or pinnae of the user is exposed to RF energy by the wireless device, for example, corresponding to positions 404c, 404e, 404f, 404i. The exposure scenarios may include a hotspot exposure scenario, where the wireless device is not held or worn on the user's body, corresponding to position 404j. Each of the various exposure scenarios described herein may correspond to a unique device state index (DSI). It will be appreciated that other exposure scenarios may be applied for RF exposure compliance.

In some cases, each of the exposure scenarios may be associated with one or more device state indexes (DSIs). For example, a head exposure scenario may be associated with a DSI equal to 0; a body-worn exposure scenario may be associated with a DSI equal to 1; an extremity exposure scenario may be associated with a DSI equal to 2; and a hotspot exposure scenario may be associated with a DSI equal to 3. In certain cases, multiple exposure scenarios may be associated with the same DSI. Other alignments of exposure scenarios to DSI or indexing/associating schemes may be used in addition to or instead of the DSI to exposure scenario associations described herein.

Although ten different positions 404a-404j are shown in FIG. 4, it will be understood that there may be other positions in addition to or instead of the positions 404a-404j being assessed for RF exposure. The number of different positions used for RF exposure tracking may depend, for example, on the sensing and/or processing capabilities of the wireless device, on the desired tissue exposure tracking resolution, etc. For example, in some cases, sensing information alone may allow the wireless device to determine whether the wireless device is positioned on or off the body, or whether the wireless device is in a head exposure scenario or non-head exposure scenario without further granularity into a precise position of the wireless device relative to the human body.

### Example Device Position Determination Relative to a Human Body

Aspects of the present disclosure provide apparatus and methods for accurately determining a position of a wireless device relative to a human body using multiple pieces, types, and/or sources of information, such as sensor information and/or usage information associated with the wireless device. The usage information may include, for example, whether a display is on or off, what application is currently running on the wireless device, and/or what audio input or output device is being used. In some cases, the usage information may supplement sensing information obtained from sensing circuitry to determine the device position. As an example, the usage information may indicate that the user is holding the wireless device in the hands, for example, due to the active application being a game and there being indications of user touches on the display. The wireless device may select the RF exposure limit (e.g., Pₗᵢₘᵢₜ) associated with hand exposure when determining a transmit power in compliance with the RF exposure limit. In certain aspects, the wireless device may select other parameter(s) instead of or in addition to the RF exposure limit, such as a device-to-human tissue spacing associated with the RF exposure limit, a time-averaging time window associated with the RF exposure limit, a total RF exposure limit, etc., to determine the transmit power. In some cases, the wireless device may confirm the device position indicated by the usage information via the sensing information, for example, via a human tissue proximity reading (e.g., via a proximity sensor or a radar detection using a FMCW sensor), or vice versa.

In certain aspects, the RF energy emitted by the wireless device may depend on a particular position of the wireless device relative to the human body. The wireless device may manage the RF energy when the exposed tissue changes from one position to another (e.g., left hand to right hand, or vice versa). The wireless device may track the RF exposure associated with a particular body location (e.g., the right hand) separately from another body location (e.g., the left hand). For example, the wireless device may treat the RF exposure encountered at a left hand separately from RF exposure encountered at a right hand or any other tissue location.

The multiple pieces of information used in the RF exposure evaluation described herein may enable an increased confidence or reliability in determining the position of the device relative to the user's body. Using multiple inputs of information or confirming a use case (e.g., left hand) using different schemes as described herein may result in a more reliable decision related to determining the device's position relative to the user's body. Identifying the device's position with high confidence may enable the wireless device to select the RF exposure parameter(s) (e.g., RF exposure limit, time-averaging time window, etc.) associated with the location of human tissue being exposed to RF energy and/or track the RF exposure encountered at the location of human tissue.

The apparatus and methods for the device position determination described herein may provide various advantages. The device position determination may facilitate increased confidence in determining the device position (e.g., where and how the transmitting device is being used near the body), which may allow the wireless device to use the determined device position for RF exposure compliance. For example, the wireless device may select the RF exposure limit corresponding to the current RF exposure scenario based on the determined device position and/or separately track or assess exposure at each of a plurality of different locations. In some cases, the device position determination may improve wireless communication performance, including, for example, an increased throughput, decreased latency, and/or increased transmission range. The improved performance may be attributable to applying the RF exposure limit associated with the actual RF exposure scenario or location instead of a conservative assumption of the RF exposure scenario, for example.

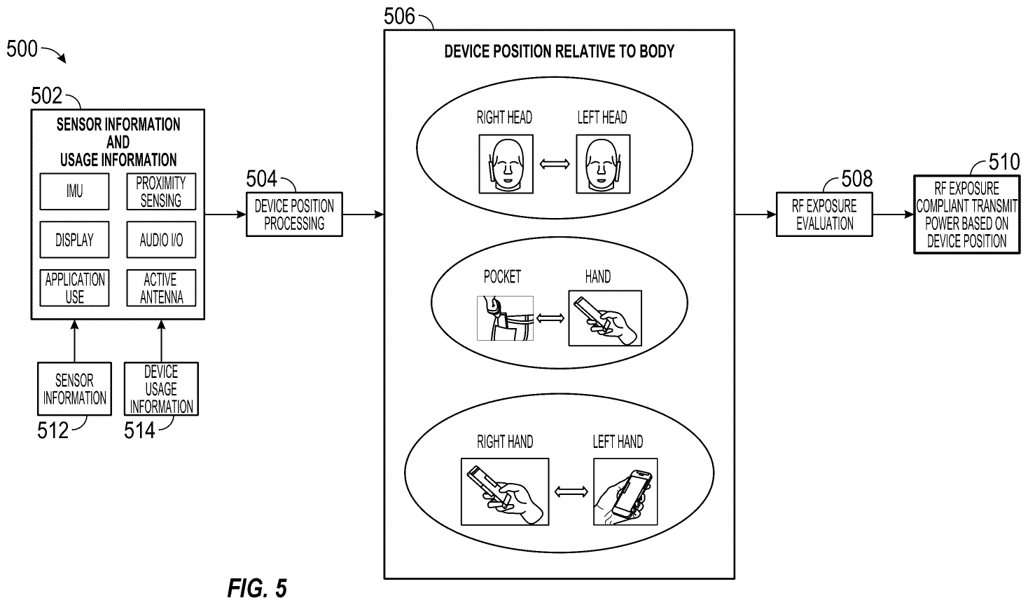

FIG. 5 is an example workflow 500 for determining a device position and applying the determined position in an RF exposure evaluation, such as time-averaged RF exposure evaluation as described herein with respect to FIG. 3. The workflow 500 may be performed, for example, by a wireless device (e.g., the first wireless device 102 in the wireless communication system 100).

The workflow 500 may optionally begin, at block 502, where the wireless device may obtain multiple pieces of information associated with device positioning, including, for example, sensor information 512 and device usage information 514. The sensor information 512 may include any of the measurements taken via the sensing circuitry 242, such as IMU measurements, proximity sensing measurements, and/or temperature measurements. The sensor information 512 may include an indication of whether the wireless device is positioned on or off the human body (e.g., on-off body information), for example, obtained via the on-off body sensor 244. The sensor information 512 may include an indication of the proximity of the wireless device to the human body, for example, obtained via the proximity sensor 246, which may include the radio 250 for radar or FMCW measurements.

The device usage information 514 may include information associated with a mode of using the wireless device. The device usage information 514 may include time-series snapshots of how the device is being used and/or operating. For example, the device usage information 514 may include display usage information (e.g., on-off indication, portrait or landscape mode, indications of user touches on the display, etc.), audio output/input usage information (e.g., normal phone mode versus speakerphone mode, which speaker is active, or which microphone or other input device is active), application usage information (e.g., which application(s) is/are currently running or which application(s) the user is/are actively interacting with), and antenna usage information (e.g., which antenna(s) is/are actively transmitting or receiving), or any combination thereof.

At block 504, the wireless device may perform device positioning processing to determine a position 506 of the wireless device relative to the body, for example, any of the positions described herein with respect to FIG. 4. The wireless device may determine the position 506 of the wireless device relative to a human body based at least in part on the sensor information 512 and/or the device usage information 514. In certain aspects, the wireless device may identify one or more events (e.g., one or more time periods of sensor information) within the sensor information 512. The wireless device may identify device usage events (e.g., one or more device usage snapshots within the corresponding time period(s) of the sensor information) that correspond in time with the sensor events based on the device usage information 514. For certain aspects, the wireless device may detect or track time-series events or movements associated with the wireless device based on the sensor information 512 and/or the device usage information 514, for example, using the detected sensor events and/or device usage events. In some examples, a DSI (not shown) may be obtained at block 504, and the sensor information 512 and/or device usage information 514 may be used at block 504 to confirm or refine the DSI (e.g., a head exposure scenario DSI may be used to determine that a left side of the user's head position 506). In some cases, the wireless device may use machine learning to identify the position 506 of the wireless device based on the sensor information 512, the device usage information 514, and/or the DSI. For example, the sensor information 512, the device usage information 514, and/or the DSI may be used as input for a machine learning model, and the machine learning model may output the position 506 of the wireless device.

As an example, the IMU measurements may indicate that the wireless device is being held in the left hand of the user, for example, due to the device orientation detected by the IMU measurements. The proximity sensor may detect certain finger positions of the user and/or a proximity of a user to a display or front of the device. The device usage information 514 may indicate that the user is engaged in a voice call. Such a combination of events may provide a high confidence that the wireless device is being held in the left hand on the left side of the user's head.

As another example, the IMU measurements may indicate that the wireless device is not moving. The proximity sensor 246 may indicate that human tissue is not being detected within a certain range. The device usage information 514 may indicate that no applications are being used by the user. For example, the display may be off, and the user may not be interacting with any application. Such a combination of events may provide a high confidence that the wireless device is in an off-body position.

At block 508, the wireless device may perform an RF exposure evaluation using the determined position 506 of the wireless device. The wireless device may select an RF exposure limit (or a corresponding maximum time-averaged transmit power limit (e.g., Pₗᵢₘᵢₜ)) associated with the determined position 506. For example, if the wireless device is at position 404a, the wireless device may select an RF exposure limit corresponding to head exposure, whereas if the wireless device is at position 404d, the wireless device may select a different RF exposure limit corresponding to body-worn exposure. The wireless device may determine a transmit power 510 in compliance with the RF exposure limit selected based at least in part on the determined position 506 of the wireless device.

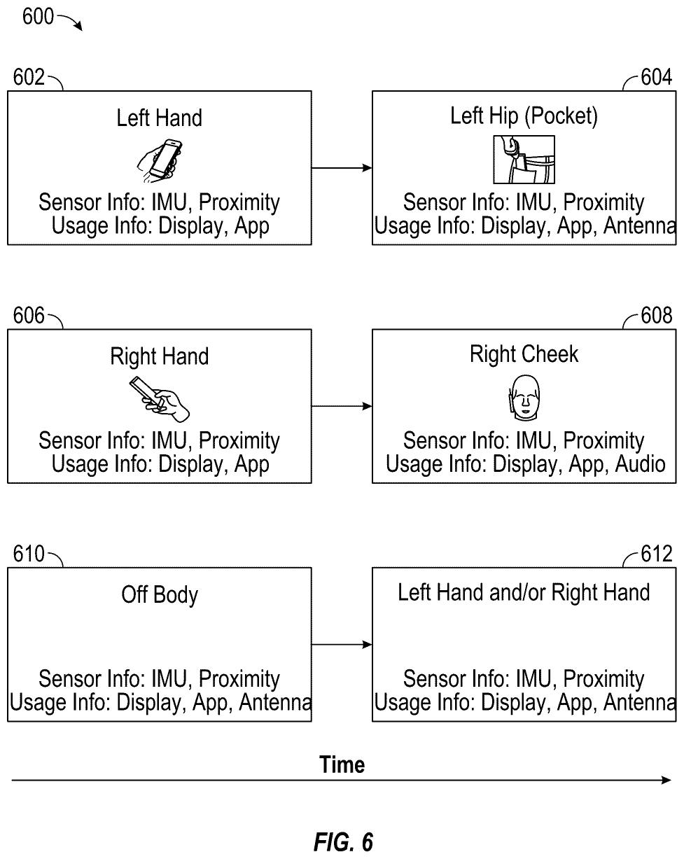

FIG. 6 is a diagram of example device movements (or events) 600 over time associated with determining the device position. In certain aspects, the wireless device may track the movements of the wireless device over time to determine the position of the wireless device. As an example, the wireless device may detect a first movement 602 where the wireless device is positioned in the user's left hand. The first movement 602 may be determined, for example, based at least in part on IMU measurements (e.g., motions indicative of a handheld position), proximity sensor measurements (e.g., an object or human tissue is detected), and device usage information 514 including display usage information (e.g., display is being touched with a left finger and in portrait mode) and application usage information (e.g., a social media application is being used).

At a subsequent occasion, the wireless device may detect a second movement 604 where the wireless device is positioned proximate to the user's left hip. In certain aspects, the first movement 602 may be used to identify the second movement 604. For example, the wireless device being held in the user's left hand may be an indication that the wireless device is located near the user's left hip if a body-worn event is detected based on the sensor information 512 and/or the device usage information 514. The second movement 604 may be determined, for example, based at least in part on IMU measurements (e.g., motions indicative of a body-worn position), proximity sensor measurements (e.g., an object or human tissue is detected), and device usage information 514 including display usage information (e.g., display is off) and application usage information (e.g., no application being displayed).

As an example, the wireless device may detect a third movement 606 where the wireless device is positioned in the user's right hand. The third movement 606 may be determined, for example, based at least in part on IMU measurements (e.g., motions indicative of a handheld position), proximity sensor measurements (e.g., an object or human tissue is detected), and device usage information 514 including display usage information (e.g., the display is unlocked with a right thumb) and application usage information (e.g., a voice call application is running).

At a subsequent occasion, the wireless device may detect a fourth movement 608 where the wireless device is positioned proximate to the user's right cheek. In certain aspects, the third movement 606 may be used to identify the fourth movement 608. For example, the wireless device being held in the user's right hand may be an indication that the wireless device is located near the user's right cheek if a cheek or head event is detected based on the sensor information 512 and/or the device usage information 514. The third movement 606 may supplement information used in determining the fourth movement 608. The fourth movement 608 may be determined, for example, based at least in part on IMU measurements (e.g., motions indicative of a handheld position and/or cheek position), proximity sensor measurements (e.g., an object or human tissue is detected), and device usage information 514 including display usage information (e.g., display is off during the voice call), application usage information (e.g., the voice call application is still running), and audio output information (e.g., an ear speaker of the wireless device is being used as the output device).

As an example, the wireless device may detect a fifth movement 610 where the wireless device is in an off-body position, for example, set on a table, desk, or a charging station. The fifth movement 610 may be determined, for example, based at least in part on IMU measurements (e.g., motions indicative of an off-body position or lack thereof), proximity sensor measurements (e.g., human tissue is not detected), and device usage information 514 including display usage information (e.g., the display is off) and application usage information (e.g., no application is currently running or being interacted with by the user).

At a subsequent occasion, the wireless device may detect a sixth movement 612 where the wireless device is positioned proximate to the user's right cheek. In certain aspects, the fifth movement 610 may be used to identify the sixth movement 612. For example, as the wireless device transitions from an off-body position to an on-body position, the wireless device may assume that a handheld position is encountered, for example, if an object (which may be assumed to be human tissue) or human tissue is detected based on the sensor information 512 and/or the device usage information 514. The fourth movement 608 may be determined, for example, based at least in part on IMU measurements (e.g., motions indicative of a handheld position), proximity sensor measurements (e.g., an object or human tissue is detected), and device usage information 514 including display usage information (e.g., display is on, in landscape mode, and touches from both thumbs are detected), application usage information (e.g., a video game is being played), and antenna information (e.g., an antenna that is not covered by a typical hand position is actively transmitting).

In certain aspects, a sequence of movements may be tracked to identify the position of the wireless device relative to the human body. The wireless device may use a transition from an off body position to a handheld position (e.g., left or right) to identify the movement to other positions, such as a right cheek position, a left cheek position, a left torso position, a right torso position, a left hip position, or a right hip position. For example, at a subsequent occasion following the sixth movement 612, the identified hand position associated with the sixth movement 612 may indicate a subsequent position, for example, the second movement 604 or the fourth movement 608.

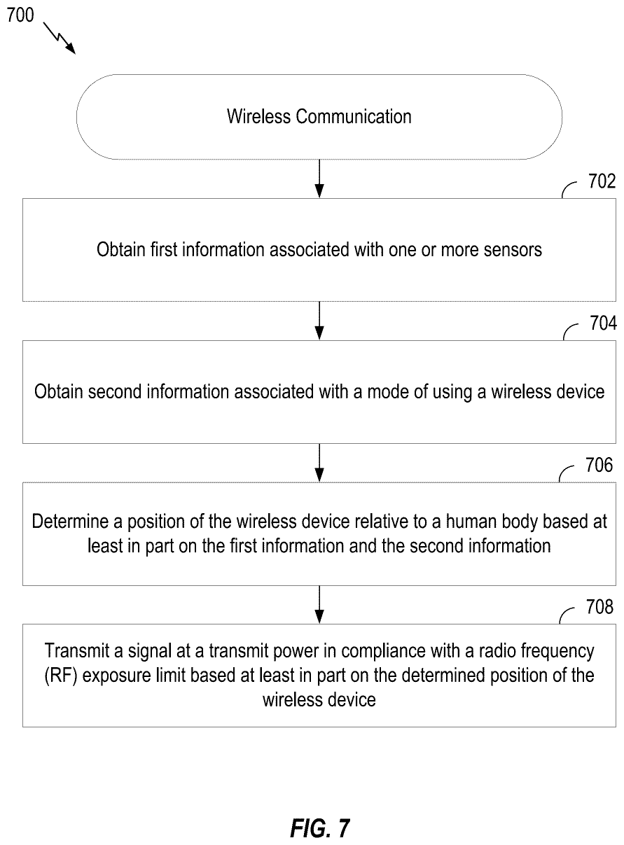

FIG. 7 is a flow diagram illustrating example operations 700 for wireless communication. The operations 700 may be performed, for example, by a wireless device (e.g., the first wireless device 102 in the wireless communication system 100). The operations 700 may be implemented as software components that are executed and run on one or more processors (e.g., the processor 210 and/or the modem 212 of FIG. 2). Further, the transmission and/or reception of signals by the wireless device in the operations 700 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 700 may optionally begin, at block 702, where the wireless device may obtain first information (e.g., the sensor information 512) associated with one or more sensors (e.g., the sensing circuitry 242). For example, the first information may include an indication of whether the wireless device is positioned on or off the human body, an indication of the proximity of the wireless device to the human body, or a combination thereof. In some examples, the first (e.g., sensor) information includes imagery or other data or information from a camera. For example, a current view of a particular camera of the wireless device may be obtained or analyzed and/or whether the camera is blocked or occluded may be obtained or determined.

At block 704, the wireless device may obtain second information (e.g., the device usage information 514) associated with a mode of using (or operating) the wireless device. The second information may include display usage information, camera usage information, audio output usage information, audio input usage information, application usage information, antenna usage information, or a combination thereof. The display usage information may include an indication of whether a display of the wireless device is on or off, an indication of an orientation associated with the display, touch history associated with the display, or a combination thereof. The camera usage information may include on-off states associated with a plurality of cameras of the wireless device, whether a user has instructed the camera to focus on a particular area or object, etc. The audio output usage information may include an indication of a particular speaker of the wireless device being used for audio output and/or a mode (e.g., for close-range/one person or projecting for multiple people or on “speakerphone” or for media display) of a speaker and/or whether audio information is being transmitted to a Bluetooth speaker device. The audio input usage information may include an indication of a particular microphone of the wireless device being used for audio input and/or a mode of a microphone and/or whether information is being received from a Bluetooth microphone device. The application usage information may include an indication of a particular application running on the wireless device. The antenna usage information may include an indication of an active antenna among a plurality of antennas of the wireless device.

At block 706, the wireless device may determine a position of the wireless device relative to a human body (e.g., any of the positions 404a-404j) based at least in part on the first information and the second information. As an example, the wireless device may determine that the wireless device is in a left handheld position, for example, based at least in part on IMU measurements (e.g., motions indicative of a handheld position), proximity sensor measurements (e.g., an object or human tissue is detected or fingers are detected), and device usage information including display usage information (e.g., display is being touched with a left finger and in portrait mode) and application usage information (e.g., a social media application is being used). In certain aspects, to determine the position, the wireless device may track one or more movements or one or more events of the wireless device over time using the first information and/or the second information, and the wireless device may determine the position of the wireless device based at least in part on the tracked movement(s), for example, as described herein with respect to FIG. 6. In some examples, an impedance signature may indicate that a device is being held by a certain hand and/or with a certain grip. In some examples, network sensors and/or information (e.g., which other devices and/or networks a device is communicating with, a fingerprint indicating where a device is in relation to access points(s) and/or whether a certain direction is blocked, for example by a portion of the user's body, etc.) may be used to determine a position of the wireless device relative to the human body.

In some examples, a confidence of one or more sensors and/or one or more position determination procedures may be evaluated when determining the position of the wireless device. For example, a confidence above a certain threshold may be a condition used to determine the position. In some such examples, any single sensor or position determination procedure may satisfy this threshold and/or an average or other combination of sensor or position information may satisfy this threshold. In some examples, the confidence threshold is different depending on the number of information source used. For example, a confidence of 95% (or some other first threshold) from a single source of information or two sources of information may be insufficient (for example, when a confidence of 99% or second threshold is the condition), but if three or more sources of information all have above a 95% confidence and all are in agreement (or do not conflict), a position may be determined. In some examples, the confidence or accuracy of the condition varies depending on potential DSI or position (e.g., determining that a device is near a head may require less accuracy than determining the device is on a table away from a user because exposure requirements for the head position may be more restrictive). In some examples, information from a number of sources with relatively low accuracy, confidence, or granularity is combined to determine a position with high(er) accuracy, confidence, or granularity. In some examples, a confidence of a source of information may determine a weight for the information when combining information from multiple sources. In some examples, if two or more positions or DSIs may be possible, the position or DSI with more limited power budget or more restrictive exposure requirements may be selected.

At block 708, the wireless device may transmit a signal at a transmit power in compliance with an RF exposure limit based at least in part on the determined position of the wireless device. For example, the wireless device may transmit the signal to another wireless communication device (e.g., any of the second wireless devices 104 depicted in FIG. 1). The signal may indicate (or carry or represent) any of various information, such as data and/or control information. In some cases, the signal may indicate (or carry or represent) one or more packets or data blocks. In certain cases, the wireless device may transmit the signal via a WWAN RAT, a WLAN RAT, short-range communications (Bluetooth), non-terrestrial communications, V2X communications, etc.

In certain aspects, the wireless device may identify an RF exposure scenario (e.g., head exposure, hand exposure, body-worn exposure, hotspot exposure, etc.) associated with the position of the wireless device, and the wireless device may identify the RF exposure limit (or the corresponding maximum time-averaged transmit power limit (e.g., Pₗᵢₘᵢₜ)) based at least in part on the identified RF exposure scenario. For example, certain values for Pₗᵢₘᵢₜ (e.g., p₀-pₙ) may be assigned to various exposure scenarios (e.g., head scenario, body scenario, extremity scenario, or hotspot scenario) and/or exposure categories (e.g., head or non-head categories) per transmit scenario including a specific frequency band (e.g., B0, B1, B2, etc.) of a RAT (e.g., CDMA, Long-Term Evolution (LTE), NR, etc.) for an antenna (e.g., a radio or antenna module) and/or antenna group. The various exposures scenarios may correspond to one or more device state indexes (DSIs), for example, as described herein with respect to FIG. 4. The wireless device may identify an exposure scenario(s) by the DSI and apply the Pₗᵢₘᵢₜ value(s) associated with the DSI. In other examples, a position with finer granularity than a DSI may be identified and a transmit power based thereon may be determined (and a signal transmit at that transmit power), for example based on separately tracking exposure across a plurality of finer granularity positions. It will be understood that using the determined position for exposure purposes is one example, and that the determined position may be utilized for in other ways and/or for other purposes.

The sensor used to obtain the first information may include any suitable device that responds to a physical stimulus (such as heat, light, electromagnetic waves, sound, pressure, magnetism, or a particular motion) and outputs a resulting impulse (e.g., a measurement) as for measurement. The sensor(s) may include, for example, an accelerometer, an inertial measurement unit (IMU), a capacitive sensor, an infrared sensor, a photonic sensor, a pressure sensor, a radar sensor, an FMCW sensor, an RF sensor, an RF impedance sensor, a transceiver, a temperature sensor, or a combination thereof.

In certain aspects, machine learning may be used to determine the position of the wireless device. For example, the wireless device may determine the position of the wireless device using a machine learning model with the first information and the second information being inputs to the machine learning model, and with the position being an output. The machine learning model may be trained via various combinations of events or movements associated with the first information and/or the second information, such as the movements described herein with respect to FIG. 6.

The position of the wireless device may include any of the positions described herein with respect to FIG. 4. As an example, the position of the wireless device may include a left cheek position, a right cheek position, a left cheek tilt position, a right cheek tilt position, a left torso position, a right torso position, a left hip position, a right hip position, a left hand position, a right hand position, a pocket, a carrier, or any combination thereof, or other positions on the body (e.g., near a left foot, etc.). The pocket may include a bag or pouch that is coupled to a garment or clothing. The carrier may include a body-worn holder, including, for example, a bag, an armband, a purse, a waist pack, a neck pouch, a backpack, etc. The wireless device may be positioned adjacent to human tissue in the pocket and/or carrier. It will be appreciated that the wireless device may expose multiple body positions to RF energy. For example, multiple body positions may be exposed to RF energy, where the wireless device is positioned in a user's hip pocket with the user's hand, where the wireless device held in the user's hand next to a cheek of the user, or where the wireless device is held in both hands of the user. In some cases, the wireless device may be segmented, for example, via a peripheral device such as Bluetooth earbuds, a wireless game controller, or a wireless virtual reality headset. In such segmented scenarios, the wireless device may determine the positions of all of the constituent devices for an RF exposure evaluation.

Aspects of the present disclosure may be applied to any of various wireless communication devices (wireless devices) that may emit RF signals causing exposure to human tissue, such as an access point, a base station and/or a CPE, performing the RF exposure compliance described herein.

### Example Communications Device

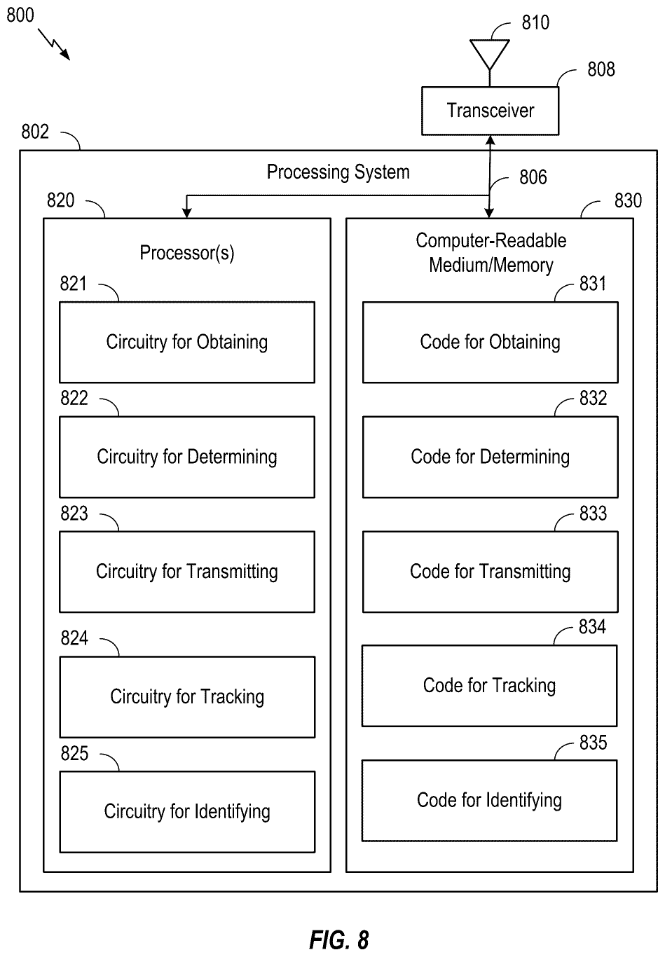

FIG. 8 depicts aspects of an example communications device 800. In some aspects, communications device 800 is a wireless communication device, such as the first wireless device 102 described above with respect to FIGS. 1 and 2.

The communications device 800 includes a processing system 802 coupled to a transceiver 808 (e.g., a transmitter and/or a receiver). The transceiver 808 is configured to transmit and receive signals for the communications device 800 via an antenna 810, such as the various signals as described herein. The processing system 802 may be configured to perform processing functions for the communications device 800, including processing signals received and/or to be transmitted by the communications device 800.

The processing system 802 includes one or more processors 820. In various aspects, the one or more processors 820 may be representative of any of the processor 210 and/or the modem 212, as described with respect to FIG. 2. The one or more processors 820 are coupled to a computer-readable medium/memory 830 via a bus 806. In certain aspects, the computer-readable medium/memory 830 is configured to store instructions (e.g., computer-executable code) that when executed by the one or more processors 820, cause the one or more processors 820 to perform the workflow 500 described with respect to FIG. 5, the operations 700 described with respect to FIG. 7, or any aspect related to the operations described herein. Note that reference to a processor performing a function of communications device 800 may include one or more processors performing that function of communications device 800.

In the depicted example, computer-readable medium/memory 830 stores code (e.g., executable instructions) for obtaining 831, code for determining 832, code for transmitting 833, code for tracking 834, code for identifying 835, or any combination thereof. Processing of the code 831-835 may cause the communications device 800 to perform the workflow 500 described with respect to FIG. 5, the operations 700 described with respect to FIG. 7, or any aspect related to operations described herein.

The one or more processors 820 include circuitry configured to implement (e.g., execute) the code stored in the computer-readable medium/memory 830, including circuitry for obtaining 821, circuitry for determining 822, circuitry for transmitting 823, circuitry for tracking 824, circuitry for identifying 825, or any combination thereof. Processing with circuitry 821-825 may cause the communications device 800 to perform the workflow 500 described with respect to FIG. 5, the operations 700 described with respect to FIG. 7, or any aspect related to operations described herein.

Various components of the communications device 800 may provide means for performing the workflow 500 described with respect to FIG. 5, operations 700 described with respect to FIG. 7, or any aspect related to operations described herein. For example, means for transmitting, sending or outputting for transmission may include the TX path 214 and/or antenna(s) 218 of the first wireless device 102 illustrated in FIG. 2 and/or transceiver 808 and antenna 810 of the communications device 800 in FIG. 8. Means for receiving or obtaining may include the RX path 216 and/or antenna(s) 218 of the first wireless device illustrated in FIG. 2 and/or transceiver 808 and antenna 810 of the communications device 800 in FIG. 8. Means for obtaining, means for identifying, means for tracking, means for controlling, means for using, and/or means for determining may include a processor, such as the processor 210 and/or modem 212 depicted in FIG. 2 and/or the processor(s) 820 in FIG. 8.

### Example Aspects

Implementation examples are described in the following numbered clauses:

Aspect 1: A method of wireless communication by a wireless device, comprising: obtaining first information associated with one or more sensors; obtaining second information associated with a mode of using the wireless device; determining a position of the wireless device relative to a human body based at least in part on the first information and the second information; and transmitting a signal at a transmit power in compliance with a radio frequency (RF) exposure limit based at least in part on the determined position of the wireless device.

Aspect 2: The method of Aspect 1, wherein the first information comprises: an indication of whether the wireless device is positioned on or off the human body; an indication of a proximity of the wireless device to the human body; or a combination thereof.

Aspect 3: The method according to any of Aspects 1-2, wherein the second information comprises: display usage information; camera usage information; audio output usage information; audio input usage information; application usage information; antenna usage information; or a combination thereof.

Aspect 4: The method of Aspect 3, wherein: the display usage information comprises an indication of whether a display of the wireless device is on or off, an indication of an orientation associated with the display, touch history associated with the display, or a combination thereof; the camera usage information comprises on-off states associated with a plurality of cameras of the wireless device, a current view of a particular camera of the wireless device, or a combination thereof; the audio output usage information comprises an indication of a particular speaker of the wireless device being used for audio output; the audio input usage information comprises an indication of a particular microphone of the wireless device being used for audio input; the application usage information comprises an indication of a particular application running on the wireless device; and the antenna usage information comprises an indication of an active antenna among a plurality of antennas of the wireless device.

Aspect 5: The method according to any of Aspects 1-4, wherein the one or more sensors comprise: an accelerometer; an inertial measurement unit (IMU); a capacitive sensor; an infrared sensor; a photonic sensor; a pressure sensor; a radar sensor; a frequency-modulated continuous-wave (FMCW) sensor; a radio frequency (RF) sensor; an RF impedance sensor; a transceiver; a temperature sensor; or a combination thereof.

Aspect 6: The method according to any of Aspects 1-5, wherein determining the position of the wireless device comprises determining the position of the wireless device using a machine learning model with the first information and the second information being inputs to the machine learning model.

Aspect 7: The method according to any of Aspects 1-6, wherein determining the position of the wireless device comprises: tracking a movement of the wireless device over time using the first information and the second information; and determining the position of the wireless device based at least in part on the tracked movement.

Aspect 8: The method according to any of Aspects 1-7, wherein the position of the wireless device comprises: a left cheek position; a right cheek position; a left cheek tilt position; a right cheek tilt position; a left torso position; a right torso position; a left hip position; a right hip position; a left hand position; a right hand position; a pocket; a carrier; or any combination thereof.

Aspect 9: The method according to any of Aspects 1-8, further comprising: identifying an RF exposure scenario associated with the position of the wireless device; and identifying the RF exposure limit based at least in part on the identified RF exposure scenario.

Aspect 10: An apparatus for wireless communication, comprising: one or more memories collectively storing executable instructions; and one or more processors coupled to the one or more memories, the one or more processors being collectively configured to execute the executable instructions to cause the apparatus to: obtain first information associated with one or more sensors; obtain second information associated with a mode of using the apparatus; determine a position of the apparatus relative to a human body based at least in part on the first information and the second information; and control transmission of a signal at a transmit power in compliance with a radio frequency (RF) exposure limit based at least in part on the determined position of the apparatus.

Aspect 11: The apparatus of Aspect 10, wherein the first information comprises: an indication of whether the apparatus is positioned on or off the human body; an indication of a proximity of the apparatus to the human body; or a combination thereof.

Aspect 12: The apparatus according to any of Aspects 10-11, wherein the second information comprises: display usage information; camera usage information; audio output usage information; audio input usage information; application usage information; antenna usage information; or a combination thereof.

Aspect 13: The apparatus of Aspect 12, wherein: the display usage information comprises an indication of whether a display of the apparatus is on or off, an indication of an orientation associated with the display, touch history associated with the display, or a combination thereof; the camera usage information comprises on-off states associated with a plurality of cameras of the apparatus, a current view of a particular camera of the apparatus, or a combination thereof; the audio output usage information comprises an indication of a particular speaker of the apparatus being used for audio output; the audio input usage information comprises an indication of a particular microphone of the apparatus being used for audio input; the application usage information comprises an indication of a particular application running on the apparatus; and the antenna usage information comprises an indication of an active antenna among a plurality of antennas of the apparatus.

Aspect 14: The apparatus according to any of Aspects 10-13, wherein the one or more sensors comprise: an accelerometer; an inertial measurement unit (IMU); a capacitive sensor; an infrared sensor; a photonic sensor; a pressure sensor; a radar sensor; a frequency-modulated continuous-wave (FMCW) sensor; a radio frequency (RF) sensor; an RF impedance sensor; a transceiver; a temperature sensor; or a combination thereof.

Aspect 15: The apparatus according to any of Aspects 10-14, wherein to determine the position of the apparatus, the one or more processors are collectively configured to execute the executable instructions to cause the apparatus to determine the position of the apparatus using a machine learning model with the first information and the second information being inputs to the machine learning model.

Aspect 16: The apparatus according to any of Aspects 10-15, wherein to determine the position of the apparatus, the one or more processors are collectively configured to execute the executable instructions to cause the apparatus to: track a movement of the apparatus over time using the first information and the second information; and determine the position of the apparatus based at least in part on the tracked movement.

Aspect 17: The apparatus according to any of Aspects 10-16, wherein the position of the apparatus comprises: a left cheek position; a right cheek position; a left cheek tilt position; a right cheek tilt position; a left torso position; a right torso position; a left hip position; a right hip position; a left hand position; a right hand position; a pocket; a carrier; or any combination thereof.

Aspect 18: The apparatus according to any of Aspects 10-17, wherein the one or more processors are collectively configured to execute the executable instructions to further cause the apparatus to: identify an RF exposure scenario associated with the position of the apparatus; and identify the RF exposure limit based at least in part on the identified RF exposure scenario.

Aspect 19: An apparatus, comprising: one or more memories collectively storing executable instructions; and one or more processors coupled to the one or more memories, the one or more processors being collectively configured to execute the executable instructions to cause the apparatus to perform a method in accordance with any of Aspects 1-9.

Aspect 20: An apparatus, comprising means for performing a method in accordance with any of Aspects 1-9.

Aspect 21: A non-transitory computer-readable medium comprising computer-executable instructions that, when executed by one or more processors of a processing system, cause the processing system to perform a method in accordance with any of Aspects 1-9.

Aspect 22: A computer program product embodied on a computer-readable storage medium comprising code for performing a method in accordance with any of Aspects 1-9.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the workflow described herein and illustrated in FIG. 5 and the operations described herein and illustrated in FIG. 7).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
obtaining first information associated with one or more sensors;
obtaining second information associated with a mode of using the wireless device;
determining a position of the wireless device relative to a human body based at least in part on the first information and the second information; and
transmitting a signal at a transmit power in compliance with a radio frequency (RF) exposure limit based at least in part on the determined position of the wireless device.

2. The method of claim 1, wherein the first information comprises:
an indication of whether the wireless device is positioned on or off the human body;
an indication of a proximity of the wireless device to the human body; or
a combination thereof.

3. The method of claim 1, wherein the second information comprises:
display usage information;
camera usage information;
audio output usage information;
audio input usage information;
application usage information;
antenna usage information; or
a combination thereof.

4. The method of claim 3, wherein:
the display usage information comprises an indication of whether a display of the wireless device is on or off, an indication of an orientation associated with the display, touch history associated with the display, or a combination thereof;
the camera usage information comprises on-off states associated with a plurality of cameras of the wireless device, a current view of a particular camera of the wireless device, or a combination thereof;
the audio output usage information comprises an indication of a particular speaker of the wireless device being used for audio output;
the audio input usage information comprises an indication of a particular microphone of the wireless device being used for audio input;
the application usage information comprises an indication of a particular application running on the wireless device; and
the antenna usage information comprises an indication of an active antenna among a plurality of antennas of the wireless device.

5. The method of claim 1, wherein the one or more sensors comprise:
an accelerometer;
an inertial measurement unit (IMU);
a capacitive sensor;
an infrared sensor;
a photonic sensor;
a pressure sensor;
a radar sensor;
a frequency-modulated continuous-wave (FMCW) sensor;
a radio frequency (RF) sensor;
an RF impedance sensor;
a transceiver;
a temperature sensor; or
a combination thereof.

6. The method of claim 1, wherein determining the position of the wireless device comprises determining the position of the wireless device using a machine learning model with the first information and the second information being inputs to the machine learning model.

7. The method of claim 1, wherein determining the position of the wireless device comprises:
tracking a movement of the wireless device over time using the first information and the second information; and
determining the position of the wireless device based at least in part on the tracked movement.

8. The method of claim 1, wherein the position of the wireless device comprises:
a left cheek position;
a right cheek position;
a left cheek tilt position;
a right cheek tilt position;
a left torso position;
a right torso position;
a left hip position;
a right hip position;
a left hand position;
a right hand position;
a pocket;
a carrier; or
any combination thereof.

9. The method of claim 1, further comprising:
identifying an RF exposure scenario associated with the position of the wireless device; and
identifying the RF exposure limit based at least in part on the identified RF exposure scenario.

10. An apparatus for wireless communication, comprising:
one or more memories collectively storing executable instructions; and
one or more processors coupled to the one or more memories, the one or more processors being collectively configured to execute the executable instructions to cause the apparatus to:
obtain first information associated with one or more sensors;
obtain second information associated with a mode of using the apparatus;
determine a position of the apparatus relative to a human body based at least in part on the first information and the second information; and
control transmission of a signal at a transmit power in compliance with a radio frequency (RF) exposure limit based at least in part on the determined position of the apparatus.

11. The apparatus of claim 10, wherein the first information comprises:
an indication of whether the apparatus is positioned on or off the human body;
an indication of a proximity of the apparatus to the human body; or
a combination thereof.

12. The apparatus of claim 10, wherein the second information comprises:
display usage information;
camera usage information;
audio output usage information;
audio input usage information;
application usage information;
antenna usage information; or
a combination thereof.

13. The apparatus of claim 12, wherein:
the display usage information comprises an indication of whether a display of the apparatus is on or off, an indication of an orientation associated with the display, touch history associated with the display, or a combination thereof;
the camera usage information comprises on-off states associated with a plurality of cameras of the apparatus, a current view of a particular camera of the apparatus, or a combination thereof;
the audio output usage information comprises an indication of a particular speaker of the apparatus being used for audio output;
the audio input usage information comprises an indication of a particular microphone of the apparatus being used for audio input;
the application usage information comprises an indication of a particular application running on the apparatus; and
the antenna usage information comprises an indication of an active antenna among a plurality of antennas of the apparatus.

14. The apparatus of claim 10, wherein the one or more sensors comprise:
an accelerometer;
an inertial measurement unit (IMU);
a capacitive sensor;
an infrared sensor;
a photonic sensor;
a pressure sensor;
a radar sensor;
a frequency-modulated continuous-wave (FMCW) sensor;
a radio frequency (RF) sensor;
an RF impedance sensor;
a transceiver;
a temperature sensor; or
a combination thereof.

15. The apparatus of claim 10, wherein to determine the position of the apparatus, the one or more processors are collectively configured to execute the executable instructions to cause the apparatus to determine the position of the apparatus using a machine learning model with the first information and the second information being inputs to the machine learning model.

16. The apparatus of claim 10, wherein to determine the position of the apparatus, the one or more processors are collectively configured to execute the executable instructions to cause the apparatus to:
track a movement of the apparatus over time using the first information and the second information; and
determine the position of the apparatus based at least in part on the tracked movement.

17. The apparatus of claim 10, wherein the position of the apparatus comprises:
a left cheek position;
a right cheek position;
a left cheek tilt position;
a right cheek tilt position;
a left torso position;
a right torso position;
a left hip position;
a right hip position;
a left hand position;
a right hand position;
a pocket;
a carrier; or
any combination thereof.

18. The apparatus of claim 10, wherein the one or more processors are collectively configured to execute the executable instructions to further cause the apparatus to:
identify an RF exposure scenario associated with the position of the apparatus; and
identify the RF exposure limit based at least in part on the identified RF exposure scenario.

19. An apparatus for wireless communication, comprising:
means for obtaining first information associated with one or more sensors;
means for obtaining second information associated with a mode of using the apparatus;
means for determining a position of the apparatus relative to a human body based at least in part on the first information and the second information; and
means for transmitting a signal at a transmit power in compliance with a radio frequency (RF) exposure limit based at least in part on the determined position of the apparatus.

20. The apparatus of claim 19, further comprising:
means for identifying an RF exposure scenario associated with the position of the apparatus; and
means for identifying the RF exposure limit based at least in part on the identified RF exposure scenario.
